(19) United States
(12) Patent Application Publication
(10) Pub. No.: US 2009/0202843 A1
(43) Pub. Date: Aug. 13, 2009

(54) Flexible substrate and manufacturing method thereof

(75) Inventor: Yoshiaki Oku, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO, LTD., Kyoto-shi (JP)

(21) Appl. No.: 12/378,074

(22) Filed: Feb. 11, 2009

(30) Foreign Application Priority Data
Feb. 12, 2008 (JP) 2008-030941

(51) Int. Cl. B32B 17/08; B05D 1/18; B32B 23/04

(52) U.S. Cl. 428/438; 427/439

(57) ABSTRACT

A flexible substrate of an aspect of the present invention includes a substrate made of cellulose-based nanofibers and low-melting-point glass deposited inside the substrate by impregnation. A flexible substrate of another aspect of the present invention includes a substrate made of cellulose-based nanofibers and low-melting-point glass joined to one of principal surfaces of the substrate. A glass transition temperature of the low-melting-point glass is equal to or below 300° C. The flexible substrate is optically transparent.

### BACKGROUND OF THE INVENTION

1. Field of the Invention

The present invention relates to a flexible substrate and a manufacturing method thereof. More specifically, the present invention relates to a flexible substrate using cellulose-based nanofibers and a manufacturing method thereof.

2. Description of Related Art

Flexible substrates are used as substrates employed in devices such as flat panel displays (FPD), as printed boards having flexibility which are also called flexible printed circuits (FPC), and so for forth. Particularly, the flexible substrates are widely used in cellular telephones, digital cameras, organic EL (electroluminescence) displays, and the like because the substrates are bendable.

Conventionally known flexible substrates typically employ plastics as base materials.

The flexible substrates made of plastics are lightweight, strong, and excellent in flexibility. However, the flexible substrates of this type have poor gas barrier properties, low dimensional stabilities due to low heat resistance temperatures, and low reliabilities. For this reason, when organic EL is formed on a plastic substrate for use as an organic EL display, this device has a problem of an extremely short life due to low resistance to water or oxygen.

There has been disclosed a flexible substrate formed by attaching an ultrathin glass substrate or a metal substrate either on one side or on both sides of a flexible substrate made of a plastic by use of an adhesive or the like (see Japanese Unexamined Patent Application Publication No. Hei 5-259591, for example). In this technique, it is possible to determine the gas barrier property depending on the substrates to be attached and thereby to achieve high gas barrier property. However, this technique has a problem of a poor dimensional stability due to considerable differences in the thermal expansion coefficients among the respective base materials including the adhesive.

There has also been disclosed a flexible substrate formed by impregnating a substrate made of cellulose-based nanofibers with a polymer serving as a matrix (see Japanese Patent Application Publication No. 2005-60680, for example). In this technique, since the substrate made of cellulose-based nanofibers is impregnated with the polymer, it is possible to define the unique thermal expansion coefficient and thereby to adjust the thermal expansion coefficient of the flexible substrate, based on the ratio of the cellulose-based nanofibers that exhibit the lower thermal expansion coefficient. Accordingly, it is possible to obtain a lower thermal expansion coefficient which is as low as that of glass. However, the polymer has a poor gas barrier property and may cause reliability degradation. Note that there have been disclosures that the cellulose-based nanofibers can be obtained by a method of subjecting plant fibers to a high-pressure homogenization process and a milling process, a method of employing bacterial cellulose, and the like (see Japanese Patent Application Publication No. 2005-60680, for example).

Meanwhile, development of low-melting-point glass to be softened at a low temperature has been in progress. For example, there is a disclosure that (CH₃)₂SiO₂—SnO—P₂O₅-based glass having a glass transition temperature ranging from room temperature to about 200° C. can be obtained by subjecting phosphoric acid and chlorosilane to direct reaction under nitrogen atmosphere, and adding tin chloride to a product of the direct reaction, followed by heating (see Japanese Patent Application Publication No. 2004-43242, for example).

The glass transition temperature of the above-described low-melting-point glass can be changed by the amount of the added tin chloride. Accordingly, it is possible to prepare the low-melting-point glass having the desired glass transition temperature. Therefore, this low-melting-point glass is expected to be employed as a matrix of a cellulose-based nanofiber substrate having transparency and an excellent gas barrier property.

### SUMMARY OF THE INVENTION

An object of the present invention is to provide an optically-transparent flexible substrate having a lower thermal expansion coefficient and an improved gas barrier property, and to provide a manufacturing method thereof.

To achieve the object, an aspect of the present invention provides a flexible substrate which includes a substrate made of cellulose-based nanofibers, and low-melting-point glass deposited inside the substrate by impregnation.

To achieve the object, another aspect of the present invention provides a flexible substrate which includes a substrate made of cellulose-based nanofibers, and low-melting-point glass joined to one of principal surfaces of the substrate.

To achieve the object, still another aspect of the present invention provides a method of manufacturing a flexible substrate which includes the steps of forming a substrate made of cellulose-based nanofibers by subjecting plant fibers to a high-pressure homogenization process and a milling process, and impregnating the substrate with low-melting-point glass by immersing the substrate in the low-melting-point glass in any of a liquid state and a gel state.

According to the present invention, it is possible to provide an optically-transparent flexible substrate having a lower thermal expansion coefficient and an improved gas barrier property, and to provide a manufacturing method thereof.

### BRIEF DESCRIPTION OF THE DRAWINGS

FIG. 1 is a schematic cross-sectional structural view of a flexible substrate according to a first embodiment of the present invention.

FIG. 2 is a schematic cross-sectional structural view of a flexible substrate according to a second embodiment of the present invention.

FIG. 3 is a schematic cross-sectional structural view of a flexible substrate according to a third embodiment of the present invention.

FIG. 4 is a schematic cross-sectional structural view of a flexible substrate according to a fourth embodiment of the present invention.

FIG. 5 is a schematic cross-sectional structural view of a flexible substrate according to a fifth embodiment of the present invention.

FIG. 6 is a schematic cross-sectional structural view of a flexible substrate according to a sixth embodiment of the present invention.

FIG. 7 is a schematic cross-sectional structural view of a flexible substrate according to a seventh embodiment of the present invention.

### DETAILED DESCRIPTION OF THE PREFERRED EMBODIMENTS

Now, flexible substrates according to embodiments of the present invention will be described below with reference to the accompanying drawings. In the following description of the drawings, identical or similar constituents are designated by identical or similar reference numerals. It is to be noted, however, that the drawings are merely schematic and may be different from those in reality. It is also to be noted that dimensional relationships and ratios may vary among the drawings.

### First Embodiment

### (Structure of Flexible Substrate)

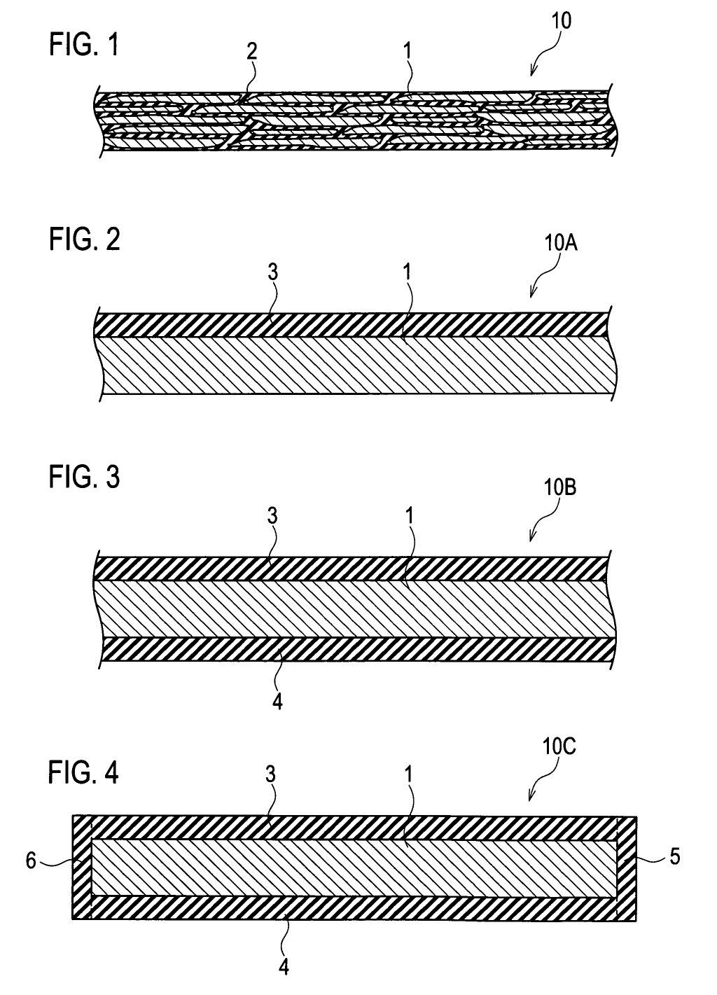

A flexible substrate according to a first embodiment of the present invention will be described with reference to FIG. 1.

As shown in FIG. 1, a flexible substrate 10 includes a substrate 1 made of cellulose-based nanofibers and low-melting-point glass 2 which is deposited inside the substrate by impregnation.

The substrate 1 is made of cellulose-based nanofibers and has a three-dimensional net-like structure. A linear thermal expansion coefficient thereof is set in a range from about 0.1×10⁻⁶ to 10×10⁻⁶K⁻¹, for example, or preferably in a range from about 1×10⁻⁶ to 5×10⁻⁶K⁻¹, for example. A thickness is set in a range from about 20 to 700 μm, for example, or preferably in a range from about 30 to 300 μm, for example, or more preferably in a range from about 30 to 100 μm, for example.

The cellulose-based nanofibers may be microfibrillated cellulose (MFC) obtained by fibrillating plant fibers into cellulose microfibers, and bacterial cellulose derived from cellulose microfibers produced by a certain type of acetic bacteria, for example.

A base unit employed here for the cellulose microfibers is a bundle of nanofibers made of fiber molecules (polymers such as cellulose). The bundle has an average diameter in a range from about 5 to 10 nm, for example, and has a three-dimensional net-like structure.

Since the size of the cellulose-based nanofibers is sufficiently small in comparison with the visible light wavelength, the substrate 1 made of the cellulose-based nanofibers is capable of reducing light scattering when formed into a composite substrate with the low-melting-point glass 2 as described later, and thereby retaining transparency of the glass.

The low-melting-point glass 2 is filled into clearances of the three-dimensional net-like structure of the substrate 1 and is joined to and deposited inside the substrate 1.

The “low-melting-point glass” is a general term for a glass material which is softened at a temperature at about 700° C. or below.

The low-melting-point glass 2 of the present invention has the glass transition temperature (Tg) in a range from about 20° C. to 300° C., for example, or preferably in a range from about 50° C. to 260° C., for example, or more preferably in a range from about 100° C. to 230° C., for example. Moreover, the glass transition temperature Tg of the low-melting-point glass 2 is preferably lower than a glass transition temperature Tg of the cellulose-based nanofibers. If the glass transition temperature Tg is below about 20° C., there is a risk of deformation at a room temperature. On the other hand, the glass transition temperature Tg that exceeds about 300° C. is not preferable because the cellulose-based nanofibers may be modified at the time of impregnation with the low-melting-point glass 2 in a manufacturing process to be described later.

The type of the low-melting-point glass 2 is not particularly limited as long as the glass transition temperature Tg is at about 300° C. or below, for example. The low-melting-point glass 2 may include PbF₂—SnF₂—P₂O₅-type fluorophosphate glass, Me₂SiO₂—SnO—P₂O₅-type glass obtained by use of acid-base reaction between an acid such as phosphoric acid and a base such as a chloride of metal and organic silicon, and PhSiO_{3/2}-type glass obtained by use of a sol-gel method, for example. Here, Me represents a methyl base while Ph represents a phenyl base or the like.

Note that the glass transition temperature Tg can be measured by use of differential scanning calorimetry (DSC).

### (Manufacturing Method)

A method of manufacturing the flexible substrate according to the first embodiment of the present invention includes the steps of forming the substrate 1 made of cellulose-based nanofibers by subjecting plant fibers to a high-pressure homogenization process and a milling process, and impregnating the substrate 1 with the low-melting-point glass 2 by immersing the substrate 1 in the low-melting-point glass 2 either in a liquid state or in a gel state.

Now, the manufacturing method will be described below in detail.

(a) First, the plant fibers such as pulp are prepared as a raw material. This raw material is processed with an ultra high-pressure homogenizer to microfibrillate the raw material by adding a strong mechanical shear force. In this process, the raw material fibers are ripped apart until the diameters of the fibers are reduced to a range from about 0.1 to 10 μm, for example. Subsequently, the microfibrillated fibers are formed into slurry and this slurry is further subjected to a milling process by a grinding machine such as a high speed grinder to obtain the MFC having an average diameter in a range from about 5 to 100 nm, for example. The sheet-like substrate 1 can be obtained by filtering this MFC with a glass filter or the like.

The surface area is drastically increased by this refining process, and the three-dimensional net-like structure is formed by the entangled microfibers.

(b) Next, the substrate 1 is immersed in the liquefied low-melting-point glass 2, which is made of the Me₂SiO₂—SnO—P₂O₅-type glass having the glass transition temperature Tg around 100° C., for example, under a pressure below the atmospheric pressure or preferably under a reduced pressure condition in a range from about 0.1 to 100 kPa for a period of about 8 to 15 hours, for instance. In this way, the cellulose-based nanofibers are tightly joined to the low-melting-point glass 2 by way of hydrogen bonding between the OH base or CH₂OH base included in the cellulose-based nanofibers and the SiOH base included in the low-melting-point glass 2 or by way of van der Waals bonding between the cellulose-based nanofibers and the low-melting-point glass 2, for example. At the time of immersion, it is preferable to add an acid such as hydrochloric acid (HCl). In this way, the acid such as HCl functions as a catalyst to remove water (H₂O) from the CH₂OH base included in the cellulose-based nanofibers and the SiOH base included in the low-melting-point glass 2, thereby forming CH₂O—Si bonding. Hence, the cellulose-based nanofibers are more tightly joined to the low-melting-point glass 2.

Since the temperature (around 200° C., for example) of the low-melting-point glass 2 in the liquid state is not higher than the glass transition temperature Tg (around 230° C., for example) of the cellulose-based nanofibers, it is possible to achieve impregnation of the low-melting-point glass 2 without causing modification of the substrate 1 made of the cellulose-based nanofibers. Moreover, by executing impregnation of the low-melting-point glass 2 under the reduced pressure condition as described above, it is possible to achieve impregnation of the low-melting-point glass 2 efficiently without leaving air in the clearances inside the substrate 1.

(c) Then, the immersed substrate 1 is taken out and dried for several hours, for example. Subsequently, the dried substrate 1 is heated and pressed to obtain the flexible substrate 10 as shown in FIG. 1, which has the thickness in a range from about 30 to 60 μm, for example, and which contains the low-melting-point glass 2 in a range from about 30% to 40%, for example.

The thermal expansion coefficient of this flexible substrate 10 is determined by the substrate 1 made of the cellulose-based nanofibers. Accordingly, the flexible substrate 10 can be provided with the low thermal expansion coefficient. In this way, it is possible to manufacture devices having excellent tolerance to manufacturing processes and having high dimensional stability. Hence, it is possible to improve product yield of such devices.

Moreover, since the low-melting-point glass 2 is deposited in the clearances inside the substrate 1 by impregnation, the flexible substrate 10 has an excellent gas barrier property. Therefore, it is possible to improve product life of organic EL devices such as organic light-emitting elements, and thereby to enhance reliability thereof.

Furthermore, since the size of the MFC is sufficiently small relative to the visible light wavelength, it is possible to retain transparency of the low-melting-point glass 2.

According to the flexible substrate of the first embodiment of the present invention and the method of manufacturing the flexible substrate, it is possible to achieve the low thermal expansion coefficient, to improve the gas barrier property, and to achieve optical transparency.

### Second Embodiment

A flexible substrate according to a second embodiment of the present invention will be described with reference to FIG. 2. In the description of the second embodiment, the same constituents as those in the first embodiment will be designated by the same reference numerals and duplicate explanation will be omitted.

As shown in FIG. 2, a flexible substrate 10A includes a substrate 1 made of cellulose-based nanofibers and low-melting-point glass 3 joined to one of principal surfaces of the substrate 1. Other features of the flexible substrate 10A are similar to those in the first embodiment and duplicate explanation will therefore be omitted.

The low-melting-point glass 3 is joined to and deposited on one of the principal surfaces of the substrate 1.

A method of manufacturing the flexible substrate 10A is different from the manufacturing method in the first embodiment in that the low-melting-point glass 3 is formed in a manner that the low-melting-point glass 3 is joined to one of the principal surfaces of the substrate 1. Since other features are similar to those in the first embodiment, duplicate explanation will be omitted herein.

In the method of manufacturing the flexible substrate 10A, the low-melting-point glass 3 either in the liquid state or in the gel state is applied to one of the principal surfaces of the substrate 1. In this way, the low-melting-point glass 3 is immersed into part, in the vicinity of the surface, of the clearances inside the substrate 1 at an interface of the substrate 1 and the low-melting-point glass 3 by way of a capillary action. Then, the low-melting-point glass 3 is joined to the substrate 1 by way of hydrogen bonding between the OH base or CH₂OH base included in the cellulose-based nanofibers and the SiOH base included in the low-melting-point glass 3 or by way of van der Waals bonding between the cellulose-based nanofibers and the low-melting-point glass 3, for example. Thus, it is possible to manufacture the flexible substrate 10A as shown in FIG. 2.

Here, it is also possible to join the low-melting-point glass 3 to the substrate 1 after subjecting the OH base or CH₂OH base in the cellulose-based nanofibers or the SiOH base in the low-melting-point glass 3 to a substitution process with a fluorine base or the like in advance. In this way, even stronger hydrogen bonding is obtained. Accordingly, the interface of the low-melting-point glass 3 and the substrate 1 has excellent affinity and adhesion.

According to the second embodiment of the present invention, the low-melting-point glass 3 is joined to and deposited on one of the principal surfaces of the substrate 1. Therefore, it is possible to enhance the gas barrier property and to enhance strength of the substrate 1 at the same time.

According to the flexible substrate of the second embodiment of the present invention and the method of manufacturing the flexible substrate, it is possible to achieve the low thermal expansion coefficient, to improve the gas barrier property, and to achieve optical transparency.

### Third Embodiment

A flexible substrate according to a third embodiment of the present invention will be described with reference to FIG. 3. In the description of the third embodiment, the same constituents as those in the first and second embodiments will be designated by the same reference numerals and duplicate explanation will be omitted.

As shown in FIG. 3, a flexible substrate 10B further includes low-melting-point glass 4 joined to the other principal surface of the substrate 1. Other features of the flexible substrate 10B are similar to those in the second embodiment and duplicate explanation will therefore be omitted.

The low-melting-point glass 4 is joined to and deposited on the other principal surface of the substrate 1.

A method of manufacturing the flexible substrate 10B is different from the manufacturing method in the second embodiment in that the low-melting-point glass 4 is formed in a manner that the low-melting-point glass 4 is joined to the other principal surface of the substrate 1. Since other features are similar to those in the second embodiment, duplicate explanation will be omitted herein.

In the method of manufacturing the flexible substrate 10B, after the low-melting-point glass 3 either in the liquid state or in the gel state is applied to one of the principal surfaces of the substrate 1, the low-melting-point glass 4 either in the liquid state or in the gel state is applied to the other principal surface of the substrate 1. In this way, the low-melting-point glass 4 is immersed into part, in the vicinity of the surface, of the clearances inside the substrate 1 at an interface of the substrate 1 and the low-melting-point glass 4 by way of a capillary action. Then, the low-melting-point glass 4 is joined to the substrate 1 by way of hydrogen bonding or by way of van der Waals bonding between the cellulose-based nanofibers and the low-melting-point glass 4, for example. Thus, it is possible to manufacture the flexible substrate 10B as shown in FIG. 3.

According to the third embodiment of the present invention, the low-melting-point glass 4 is further joined to and deposited on the other principal surface of the substrate 1. Therefore, it is possible to further enhance the gas barrier property and the strength of the substrate 1.

According to the flexible substrate of the third embodiment of the present invention and the method of manufacturing the flexible substrate, it is possible to achieve the low thermal expansion coefficient, to improve the gas barrier property, and to achieve optical transparency.

### Fourth Embodiment

A flexible substrate according to a fourth embodiment of the present invention will be described with reference to FIG. 4. In the description of the fourth embodiment, the same constituents as those in the first and third embodiments will be designated by the same reference numerals and duplicate explanation will be omitted.

As shown in FIG. 4, a flexible substrate 10C further includes low-melting-point glasses 5 and 6 joined to both end surfaces of the substrate 1. Other features of the flexible substrate 10C are similar to those in the third embodiment and duplicate explanation will therefore be omitted.

The low-melting-point glasses 5 and 6 are joined to and deposited on both end surfaces of the substrate 1.

A method of manufacturing the flexible substrate 10C is different from the manufacturing method in the third embodiment in that the low-melting-point glasses 5 and 6 are formed in a manner that the low-melting-point glasses 5 and 6 are joined to both of the end surfaces of the substrate 1. Since other features are similar to those in the third embodiment, duplicate explanation will be omitted herein.

In the method of manufacturing the flexible substrate 10C, the low-melting-point glasses 5 and 6 either in the liquid state or in the gel state are formed on both of the end surfaces of the substrate 1 either by coating or dipping. In this way, the low-melting-point glasses 5 and 6 are applied to both of the end surfaces of the flexible substrate 10B. Thus, it is possible to manufacture the flexible substrate 10C as shown in FIG. 4.

According to the fourth embodiment of the present invention, the low-melting-point glasses 5 and 6 are further joined to and deposited on both of the end surfaces of the flexible substrate 10B. Therefore, it is possible to further enhance the gas barrier property thereof.

According to the flexible substrate of the fourth embodiment of the present invention and the method of manufacturing the flexible substrate, it is possible to achieve the low thermal expansion coefficient, to improve the gas barrier property, and to achieve optical transparency.

### Fifth Embodiment

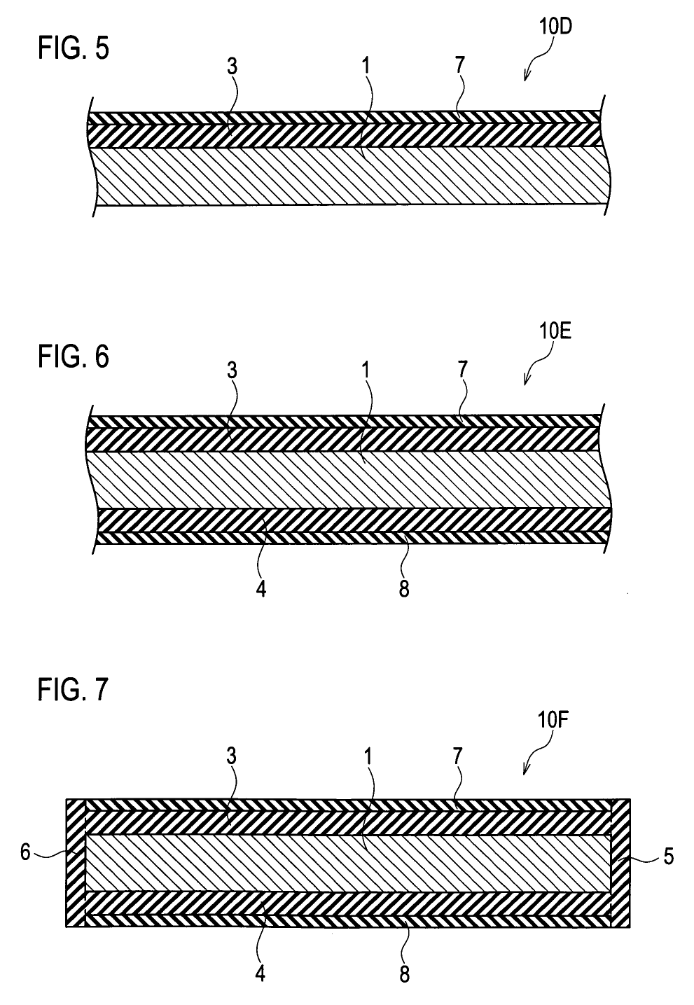

A flexible substrate according to a fifth embodiment of the present invention will be described with reference to FIG. 5. In the description of the fifth embodiment, the same constituents as those in the first and second embodiments will be designated by the same reference numerals and duplicate explanation will be omitted.

As shown in FIG. 5, a flexible substrate 10D further includes high-melting-point glass 7, which has a glass transition temperature higher than the glass transition temperature of the low-melting-point glass 3, and which is joined to a surface of the low-melting-point glass 3. Other features of the flexible substrate 10D are similar to those in the second embodiment and duplicate explanation will therefore be omitted.

The high-melting-point glass 7 is joined to and deposited on the surface of the low-melting-point glass 3.

The high-melting-point glass 7 may be silica glass or borosilicate glass, for example.

A method of manufacturing the flexible substrate 10D is different from the manufacturing method in the second embodiment in that the high-melting-point glass 7 is formed in a manner that the high-melting-point glass 7 is joined to the surface of low-melting-point glass 3. Since other features are similar to those in the second embodiment, duplicate explanation will be omitted herein.

In the method of manufacturing the flexible substrate 10D, after the low-melting-point glass 3 either in the liquid state or in the gel state is applied to one of the principal surfaces of the substrate 1, the high-melting-point glass 7 is attached to the surface of the low-melting-point glass 3. Thus, it is possible to manufacture the flexible substrate 10D as shown in FIG. 5.

According to the fifth embodiment of the present invention, the high-melting-point glass 7 is further joined to and deposited on the surface of the low-melting-point glass 3. Therefore, it is possible to enhance heat resistance thereof.

According to the flexible substrate of the fifth embodiment of the present invention and the method of manufacturing the flexible substrate, it is possible to achieve the low thermal expansion coefficient, to improve the gas barrier property, and to achieve optical transparency.

### Sixth Embodiment

A flexible substrate according to a sixth embodiment of the present invention will be described with reference to FIG. 6. In the description of the sixth embodiment, the same constituents as those in the first and fifth embodiments will be designated by the same reference numerals and duplicate explanation will be omitted.

As shown in FIG. 6, a flexible substrate 10E further includes high-melting-point glass 8, which has a glass transition temperature higher than the glass transition temperature of the low-melting-point glass 4, and which is joined to a surface of the low-melting-point glass 4. Other features of the flexible substrate 10E are similar to those in the fifth embodiment and duplicate explanation will therefore be omitted.

The high-melting-point glass 8 is joined to and deposited on the surface of the low-melting-point glass 4.

A method of manufacturing the flexible substrate 10E is different from the manufacturing method in the fifth embodiment in that the high-melting-point glass 8 is formed in a manner that the high-melting-point glass 8 is joined to the surface of low-melting-point glass 4. Since other features are similar to those in the fifth embodiment, duplicate explanation will be omitted herein.

In the method of manufacturing the flexible substrate 10E, after the low-melting-point glass 4 either in the liquid state or in the gel state is applied to the other principal surface of the substrate 1, the high-melting-point glass 8 is attached to the surface of the low-melting-point glass 4. Thus, it is possible to manufacture the flexible substrate 10E as shown in FIG. 6.

According to the sixth embodiment of the present invention, the high-melting-point glass 8 is further joined to and deposited on the surface of the low-melting-point glass 4. Therefore, it is possible to further enhance heat resistance thereof.

According to the flexible substrate of the sixth embodiment of the present invention and the method of manufacturing the flexible substrate, it is possible to achieve the low thermal expansion coefficient, to improve the gas barrier property, and to achieve optical transparency.

### Seventh Embodiment

A flexible substrate according to a seventh embodiment of the present invention will be described with reference to FIG. 7. In the description of the seventh embodiment, the same constituents as those in the first and fourth embodiments will be designated by the same reference numerals and duplicate explanation will be omitted.

As shown in FIG. 7, a flexible substrate 10F further includes high-melting-point glasses 7 and 8 which have a glass transition temperature higher than the glass transition temperature of the low-melting-point glasses 3 and 4, and which are respectively joined to the surfaces of the low-melting-point glasses 3 and 4. Other features of the flexible substrate 10F are similar to those in the fourth embodiment and duplicate explanation will therefore be omitted.

The high-melting-point glasses 7 and 8 are respectively joined to and deposited on the surfaces of the low-melting-point glasses 3 and 4.

A method of manufacturing the flexible substrate 10F is different from the manufacturing method in the fourth embodiment in that the high-melting-point glasses 7 and 8 are respectively formed in a manner that the high-melting-point glass 7 and 8 are joined to the surfaces of low-melting-point glasses 3 and 4. Since other features are similar to those in the fourth embodiment, duplicate explanation will be omitted herein.

In the method of manufacturing the flexible substrate 10F, after the low-melting-point glass 3 either in the liquid state or in the gel state is applied to one of the principal surfaces of the substrate 1, the high-melting-point glass 7 is attached to the surface of the low-melting-point glass 3. Next, after the low-melting-point glass 4 either in the liquid state or in the gel state is applied to the other principal surface of the substrate 1, the high-melting-point glass 8 is attached to the surface of the low-melting-point glass 4. Subsequently, the low-melting-point glasses 5 and 6 are formed on both of the end surfaces of the substrate 1 either by coating or dipping. Thus, it is possible to manufacture the flexible substrate 10F as shown in FIG. 7.

According to the seventh embodiment of the present invention, the high-melting-point glasses 7 and 8 are further joined to and deposited on the surfaces of the low-melting-point glasses 3 and 4. Therefore, it is possible to further enhance heat resistance thereof.

According to the flexible substrate of the seventh embodiment of the present invention and the method of manufacturing the flexible substrate, it is possible to achieve the low thermal expansion coefficient, to improve the gas barrier property, and to achieve optical transparency.

### Other Embodiments

The present invention has been described above in detail with the first to seventh embodiments. However, it is obvious to those skilled in the art that the present invention shall not be limited only to the first to seventh embodiments described in this specification. Various modified and altered embodiments of the present invention are possible without departing from the spirit and scope of the invention to be defined by the appended claims. Therefore, it is to be understood that the description of this specification is merely intended to explain certain examples and is not intended to limit or to restrict in any way the scope of the present invention. Now, partial modifications of the above-described first to seventh embodiments will be described below.

For example, the method of manufacturing the flexible substrate according to the first embodiment has been described as the example of producing the cellulose-based nanofibers by using the plant fibers as the raw material. Instead, it is also possible to produce the cellulose-based nanofibers by use of bacterial cellulose. This method can also achieve similar effects to those of the first to seventh embodiments.

Meanwhile, the flexible substrates according to the above-described first to seventh embodiments are applicable to substrates of displays such as organic EL displays, integrated circuits, micro-electro-mechanical systems (MEMS) loading micro-electro-mechanical devices, various sensors, and so forth.

What is claimed is:

1. A flexible substrate comprising:
a substrate made of cellulose-based nanofibers; and
low-melting-point glass deposited inside the substrate by impregnation.

2. A flexible substrate comprising:
a substrate made of cellulose-based nanofibers; and
low-melting-point glass joined to one of principal surfaces of the substrate.

3. The flexible substrate according to claim 2, further comprising low-melting-point glass joined to the other principal surface of the substrate.

4. The flexible substrate according to claim 3, further comprising low-melting-point glass joined to both end surfaces of the substrate.

5. The flexible substrate according to claim 1, wherein the substrate is joined to the low-melting-point glass by way of any of hydrogen bonding and van der Waals bonding.

6. The flexible substrate according to claim 2, wherein the substrate is joined to the low-melting-point glass by way of any of hydrogen bonding and van der Waals bonding.

7. The flexible substrate according to claim 3, wherein the substrate is joined to the low-melting-point glass by way of any of hydrogen bonding and van der Waals bonding.

8. The flexible substrate according to claim 4, wherein the substrate is joined to the low-melting-point glass by way of any of hydrogen bonding and van der Waals bonding.

9. The flexible substrate according to claim 2, further comprising high-melting-point glass being joined to a surface of the low-melting-point glass and having a glass transition temperature higher than a glass transition temperature of the low-melting-point glass.

10. The flexible substrate according to claim 3, further comprising high-melting-point glass being joined to a surface of the low-melting-point glass and having a glass transition temperature higher than a glass transition temperature of the low-melting-point glass.

11. The flexible substrate according to claim 4, further comprising high-melting-point glass being joined to a surface of the low-melting-point glass and having a glass transition temperature higher than a glass transition temperature of the low-melting-point glass.

12. The flexible substrate according to claim 6, further comprising high-melting-point glass being joined to a surface of the low-melting-point glass and having a glass transition temperature higher than a glass transition temperature of the low-melting-point glass.

13. The flexible substrate according to claim 1, wherein a glass transition temperature of the low-melting-point glass is equal to or below 300° C.

14. The flexible substrate according to claim 2, wherein a glass transition temperature of the low-melting-point glass is equal to or below 300° C.

15. The flexible substrate according to claim 1, wherein the low-melting-point glass has a glass transition temperature lower than a glass transition temperature of the cellulose-based nanofibers.

16. The flexible substrate according to claim 2, wherein the low-melting-point glass has a glass transition temperature lower than a glass transition temperature of the cellulose-based nanofibers.

17. The flexible substrate according to claim 1, wherein the flexible substrate is optically transparent.

18. The flexible substrate according to claim 2, wherein the flexible substrate is optically transparent.

19. A method of manufacturing a flexible substrate comprising the steps of:
forming a substrate made of cellulose-based nanofibers by subjecting plant fibers to a high-pressure homogenization process and a milling process; and
impregnating the substrate with low-melting-point glass by immersing the substrate in the low-melting-point glass in any of a liquid state and a gel state.
